(19) United States
(12) Patent Application Publication
(10) Pub. No.: US 2026/0065671 A1
(43) Pub. Date: Mar. 5, 2026

(54) METHOD AND COMPUTER SYSTEM FOR INFERENCE USING A VISION-LANGUAGE MODEL BASED ON CACHED INFORMATION ASSOCIATED WITH INPUT PROMPT

(71) Applicant: NOTA, INC., Daejeon (KR)

(72) Inventors: Seungmin Yang, Daejeon (KR); Tae-Ho Kim, Daejeon (KR); Jewon Lee, Daejeon (KR)

(73) Assignee: NOTA, INC., Daejeon (KR)

(21) Appl. No.: 18/916,190

(22) Filed: Oct. 15, 2024

(30) Foreign Application Priority Data
Sep. 5, 2024 (KR) 10-2024-0120588

(51) Int. Cl. G06V 20/40; G06F 40/284; G06V 10/774

(52) U.S. Cl. CPC G06V 20/41; G06F 40/284; G06V 10/774

(57) ABSTRACT

Provided is an inference method using a vision-language model (VLM). The VLM is pretrained to sequentially generate inference results for consecutive inputs according to an input prompt, and the inference method includes caching information associated with the input prompt acquired during an operation for generating a first inference result for a first input among the consecutive inputs to the VLM, maintaining the cached information after the first inference result is generated; and generating a second inference result for a second input following the first input among the consecutive inputs to the VLM, based on the cached information.

### CROSS-REFERENCE TO RELATED APPLICATION

This application claims the priority benefit of Korean Patent Application No. 10-2024-0120588, filed on Sep. 5, 2024, in the Korean Intellectual Property Office, the disclosure of which is incorporated herein by reference

### BACKGROUND

### 1. Field

The present disclosure relates to an inference method and a computer system using a vision-language model, and more particularly, to a method and a computer system for caching information associated with an input prompt in the process of processing a first input among consecutive inputs and performing inference on remaining consecutive inputs using the cached information.

### 2. Description of Related Art

A vision-language model (VLM) is a multimodal generative model configured to generate an answer to an input prompt (question) by adding visual information to an existing language model (e.g., large language model (LLM)).

A typical computer vision recognition algorithm has the degraded ability in visual understanding using context implied within visual information including an input, particularly, prior knowledge. This is because it is greatly affected by inductive bias generated from data used in a learning process. Also, it is impossible to perform complex inference based on visual information, for example, to infer a situation from the visual information or to perform analogy about an object. In comparison thereto, the VLM may perform inference beyond what is simply seen from the visual information by utilizing both processing of the visual information and logical inference ability (reasoning) based on the language ability of the LLM. For example, the VLM may perform inference to detect presence or absence of a specific event (e.g., vehicle accident and fire) from visual information included in an input video (image, video, and etc.).

In the case of performing inference on consecutive inputs using the VLM, an inference speed may decrease as a large amount of operations are required. Therefore, when performing inference by processing consecutive inputs using the VLM, there is a need for technology to reduce unnecessary repetitive operations on redundant information and to increase the inference speed of the VLM. Also, there is a need for technology to implement the VLM to be operable even on a device with limited resources such as an edge device.

The aforementioned information is simply to help understanding and may include content that does not form a portion of the art and may not include what the art may present to one skilled in the art.

### SUMMARY

An example embodiment may provide a method of using a vision-language model (VLM) pretrained to sequentially generate inference results for consecutive inputs according to an input prompt and, here, caching information associated with the input prompt acquired during an operation for generating a first inference result for a first input among consecutive inputs to the VLM and using the cached information to generate an inference result for a subsequent input.

An example embodiment may provide a method of caching a text token constituting an input prompt and attention information acquired during an operation for generating an inference result for a first input as information associated with the input prompt, to reduce unnecessary repetitive operations when the VLM processes consecutive inputs.

According to an aspect, there is provided an inference method using a vision-language model (VLM), performed by a computer system, the VLM being pretrained to sequentially generate inference results for consecutive inputs according to an input prompt, the inference method including caching information associated with the input prompt acquired during an operation for generating a first inference result for a first input among the consecutive inputs to the VLM, maintaining the cached information after the first inference result is generated, and generating a second inference result for a second input following the first input among the consecutive inputs to the VLM, based on the cached information.

The consecutive inputs may correspond to a video stream including a plurality of frames, the first input may be a first frame being an initial frame among the frames, and the second input may be a subsequent frame following the first frame among the frames, the input prompt may be a text prompt applied to analyze or explain each frame of the frames using the VLM, and the first inference result may include text that analyzes or explains the first frame, and the second inference result may include text that analyzes or explains the subsequent frame.

The cached information associated with the input prompt may include a text token constituting the input prompt and attention information acquired during an operation for generating the first inference result.

As a first input embedding generated based on the input prompt and the first input is input to at least one transformer including an attention mechanism constituting the VLM, a first output token constituting the first inference result may be generated, and at least one of a key (e.g., key representation or vector), a value (e.g., key representation or vector), and an attention output of the attention mechanism may be cached as the attention information.

The VLM may include a plurality of transformers, and the caching may include caching the text token constituting the input prompt and at least one of the key, the value, and the attention output of the attention mechanism of each of the plurality of transformers constituting the VLM as the attention information.

The first input may include an image or a frame, and the first input embedding may be generated based on the text token constituting the input prompt and a first visual token constituting the first input, and the first visual token may be generated by performing padding at least one pixel outside the image or the frame: generating visual tokens from the padded image or frame using a visual encoder; and removing at least one unrelated visual token among the visual tokens.

The removing may include removing a visual token corresponding to a location of the padded pixel among the visual tokens as the unrelated visual token.

The removing may include removing a visual token of which similarity to the text token is less than or equal to a predetermined value among the visual tokens as the unrelated visual token.

The second input may include an image or a frame, and the generating of the second inference result may include generating a second visual token constituting the second input; and generating a second output token constituting the second inference result based on the cached attention information as the second visual token is input to the transformer.

The generating of the second visual token may include padding at least one pixel outside the image or the frame that is the second input: generating visual tokens from the padded image or frame using a visual encoder; and removing at least one unrelated visual token among the visual tokens.

The removing may include removing a visual token corresponding to a location of the padded pixel among the visual tokens as the unrelated visual token.

The removing may include removing a visual token of which similarity to the cached text token is less than or equal to a predetermined value among the visual tokens as the unrelated visual token.

The VLM may be pretrained using a training input embedding that includes a training visual token and a training text token, and the training input embedding may be configured such that the training text token is arranged before the training visual token.

The first input embedding may be configured such that the text token constituting the input prompt is arranged before a first visual token constituting the first input.

The cached information may be stored in a form acquirable by the VLM when performing an operation for generating the second inference result for the second input, and is maintained without being removed until the inference results are generated for all of the consecutive inputs.

According to another aspect, there is provided a computer system to perform inference using a vision-language model (VLM), the VLM being pretrained to sequentially generate inference results for consecutive inputs according to an input prompt, the computer system including at least one processor configured to execute computer-readable instructions on the computer system, wherein the at least one processor is configured to cache information associated with the input prompt acquired during an operation for generating a first inference result for a first input among the consecutive inputs to the VLM, to maintain the cached information after the first inference result is generated, and to generate a second inference result for a second input following the first input among the consecutive inputs to the VLM, based on the cached information.

An example embodiment may cache information associated with an input prompt acquired during an operation for generating an inference result for a first input and using the cached information to generate inference results for subsequent inputs, when performing inference on consecutive inputs using a VLM, thereby reducing unnecessary repetitive operations when performing inference. Therefore, it is possible to increase the inference speed for consecutive inputs using the VLM and to build the VLM that may be mounted and implemented on an edge device.

### BRIEF DESCRIPTION OF THE DRAWINGS

FIG. 1 illustrates an inference method using a vision-language model (VLM) according to an example embodiment.

FIG. 2 illustrates a computer system to perform an inference method using a VLM according to an example embodiment.

FIG. 3 is a flowchart illustrating an inference method using a VLM according to an example embodiment.

FIG. 4 illustrates a method of generating a significant visual token by performing padding processing on an input image and then removing a visual token corresponding to a padded area according to an example.

FIG. 5 illustrates a method of removing unrelated token(s) based on similarity to text tokens and generating a visual token according to an example.

FIG. 6 illustrates a method of processing a first input among consecutive inputs to perform inference by a VLM according to an example.

FIG. 7 illustrates a method of processing an N^{th} input among consecutive inputs to perform inference by a VLM according to an example.

FIG. 8 illustrates a method of caching information associated with an input prompt while a VLM performs inference on a first input and performing inference on an N^{th} input using the cached information according to an example.

FIG. 9 illustrates a method of performing, by a VLM, inference using cached information associated with an input prompt when processing visual tokens of consecutive inputs generated by the methods described with reference to FIGS. 4 and 5, according to an example.

### DETAILED DESCRIPTION

Hereinafter, example embodiments of the present invention will be described in detail with reference to the accompanying drawings.

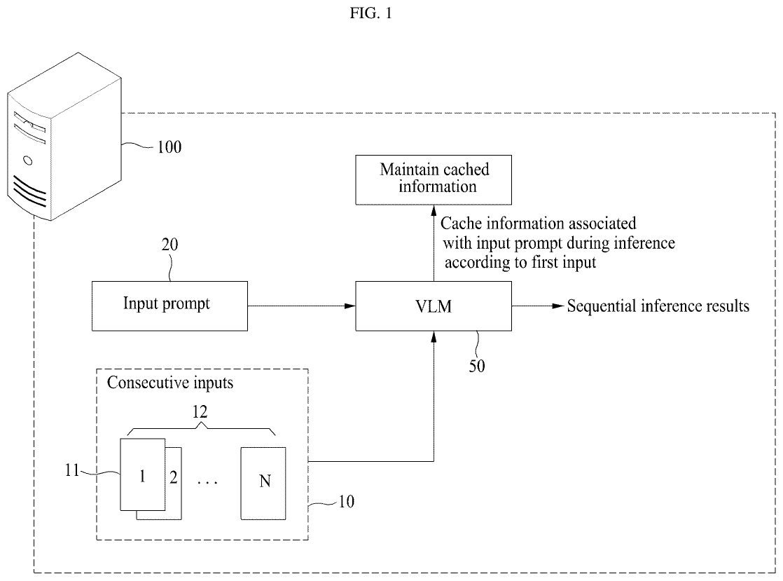

FIG. 1 illustrates an inference method using a vision-language model (VLM) according to an example embodiment.

A method of generating, by a computer system 100, an inference result by processing an input 10 according to a predetermined input prompt 20 using a VLM 50.

The VLM 50 may be an artificial intelligence model that may process and understand, for example, visual information such as video (image and/or video) and linguistic information (e.g., text, audio, and voice). The VLM 50 may be configured to perform a task of analyzing the input 10 and explaining visual data represented by the input 10 in text according to the input prompt 20 or finding an answer from the input 10 according to a query represented by the input prompt 20 configured in text. For example, in an example embodiment, the input 10 may be configured as the consecutive inputs 10, and the VLM 50 may be configured to sequentially output an inference result for each of the consecutive inputs 10.

The consecutive inputs 10 may be, for example, consecutive images or consecutive frames of a video or a moving picture. That is, each of the consecutive inputs 10 may represent a single image or frame. For example, the consecutive inputs 10 may include N inputs (N is an integer of 2 or more) and, in FIG. 1, a first input 11 and remaining inputs 12 are separately illustrated. The first input 11 may represent a first image or frame, and the remaining inputs 12 may represent images or frames following the first input 11.

As illustrated, the VLM 50 may be mounted or implemented in the computer system 100. Alternatively, unlike what is illustrated, the VLM 50 may be built outside the computer system 100 and implemented such that the computer system 100 is accessible to the VLM 50.

In the following, for clarity of description, it is described that the computer system 100 performs inference on the inputs 10 using the VLM 50.

The VLM 50 may be pretrained to sequentially generate inference results for the consecutive inputs 10 according to the input prompt 20. Therefore, the computer system 100 may generate the inference result for each of the consecutive inputs 10.

The computer system 100 may cache and maintain information associated with the input prompt 20 acquired during an operation for generating a first inference result for a first input among the consecutive inputs 10 to the VLM 50. Here, the first input refers to any one of the inputs 10, for example, the first input 11.

The computer system 100 may maintain such cached information even after the first inference result for the first input is generated, and may generate a second inference result for a second input following the first input among the consecutive inputs 10 to the VLM 50 based on the cached information. For example, the computer system 100 may generate inference results by processing the inputs 12 following the first input 11 using the cached information.

The consecutive inputs 10 (e.g., consecutive frames) are highly likely to contain similar visual information and the same input prompt 20 is applied to each of the consecutive inputs 10. Therefore, as in an example embodiment, caching information associated with the input prompt 20 acquired during the operation for generating the inference result for the first input (or first input 11) and using the cached information for inference on the subsequent second input (or inputs 12) may significantly reduce redundant operations in inferring the inputs 10.

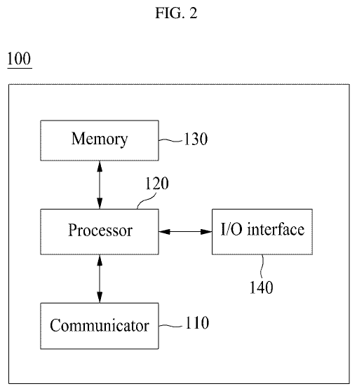

A method of caching, by the computer system 100, information associated with the input prompt 20 and a method of performing, by the computer system 100, inference on the inputs 10 using the cached information are further described with reference to FIGS. 2 to 9 below.

FIG. 2 illustrates a computer system to perform an inference method using a VLM according to an example embodiment.

The computer system 100 may be an electronic device with the aforementioned VLM 50 built or accessible to the VLM 50. As described above, the computer system 100 may generate sequential inference results by processing the consecutive inputs 10 using the VLM 50 and may cache and maintain information associated with the input prompt 20 acquired during an operation for generating a first inference result for a first input. Also, the computer system 100 may generate a second inference result for second input(s) following the first input using this cached information.

The computer system 100 may be a server in which the VLM 50 is implemented. Meanwhile, the VLM 50 of the example embodiment may perform inference using cached information associated with the input prompt, so the inference speed may be very fast and the model may be implemented to be relatively lightweight. This VLM 50 may be implemented on an edge device. In this aspect, the computer system 100 may be an edge device. The edge device refers to a computing device and may include, for example, a personal computer (PC), a laptop computer, a smartphone, a tablet, an Internet of things (IOT) device, or a wearable computer.

As illustrated, the computer system 100 may include a memory 130, a processor 120, a communicator 110, and an input/output (I/O) interface 140.

The memory 130 may include a permanent mass storage device, such as random access memory (RAM), read only memory (ROM), and disk drive, as a computer-readable recording medium. Here, the ROM and the permanent mass storage device may be included as a separate permanent storage device separate from the memory 130. Also, an operating system (OS) and at least one program code may be stored in the memory 130. Such software components may be loaded from another computer-readable recording medium separate from the memory 130. The separate computer-readable recording medium may include a computer-readable recording medium, for example, a floppy drive, a disk, a tape, a DVD/CD-ROM drive, and a memory card. In another example embodiment, the software components may be loaded to the memory 130 through the communicator 110, instead of the computer-readable recording medium. The memory 130 may be provided with a space/area for caching information associated with the input prompt as an area separate (or distinguished) from the VLM 50 or an area outside the VLM 50. “Caching” in an example embodiment may be “store.” Cached ‘information associated with the input prompt acquired during the operation of generating the first inference result for the first input’ may be stored without being deleted (or flushed) even after the first inference result is generated, and may be maintained until generation of the second inference result for the remaining second input(s) following the first input is completed.

The processor 120 may be configured to process instructions of a computer program by performing basic arithmetic operations, logic operations, and I/O operations. The instructions may be provided by the memory 130 or the communicator 110 to the processor 120. For example, the processor 120 may be configured to execute the received instructions according to the program code loaded to the memory 130. The processor 120 may generate sequential inference results by processing the consecutive inputs 10 using the aforementioned VLM 50 and may cache, in the aforementioned memory 130, and maintain information associated with the input prompt 20 acquired during the operation of generating the first inference result for the first input. Also, the processor 120 may access this cached information and may generate the second inference result for the second input(s) following the first input using the cached information.

The communicator 110 may be a component for the computer system 100 to communicate with another apparatus. That is, the communicator 110 may be a hardware module, such as an antenna, a data bus, a network interface card, a network interface chip, and a networking interface port of the computer system 100 that transmits/receives data and/or information to/from the other apparatus or a software module such as a network device driver or a networking program.

The I/O interface 140 may be a device for interfacing with an input device such as a keyboard and a mouse and an output device such as a display and a speaker.

The processor 120 may manage the components of the computer system 100, may execute a program or an application for performing the method, and may process operations required for executing the program or the application and processing data. The processor 120 may be at least one processor (CPU and/or GPU) of the computer system 100 or at least one core within the processor.

Also, in example embodiments, the computer system 100 and the processor 120 may include a greater number of components than the number of illustrated components.

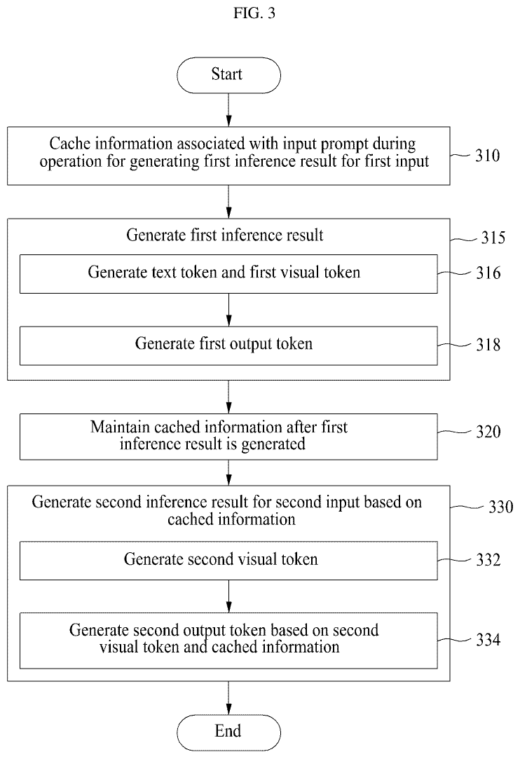

A method of caching information associated with the input prompt and performing the inference method using the VLM 50 according to the operation of the computer system 100 is further described with reference to FIGS. 3 to 9 below.

Description related to technical features made above with reference to FIG. 1 may also be applied to FIG. 2 as is and thus, repeated description is omitted.

In the following detailed description, an operation performed by the components of the computer system 100 or the processor 120 may be described as an operation performed by the computer system 100, for clarity of description.

FIG. 3 is a flowchart illustrating an inference method using a VLM according to an example embodiment.

A method of caching, by the computer system 100, information associated with the input prompt and generating inference results for the inputs 10 using the VLM 50 is described with reference to FIG. 3.

As described above, the VLM 50 may be pretrained to sequentially generate inference results for the consecutive inputs(s) 10 according to the input prompt. The input prompt may be preset in consideration of results to be inferred or analyzed for the inputs 10 by an administrator or a user of the VLM 50. The input prompt may be a text prompt.

In operation 310, the computer system 100 may cache information associated with the input prompt 20 acquired during the operation for generating the first inference result for the first input 11 among the consecutive inputs 10 to the VLM 50. The consecutive inputs 10 may be a single moving picture or video. For example, the consecutive inputs 10 may be a video stream that includes a plurality of frames, and the first input 11 may be the first frame 11 among the frames constituting the video stream. The first frame 11 may be an initial frame among the frames constituting the video stream. The computer system 100 may cache corresponding information by storing information associated with the input prompt 20 in a separate space/area of the memory 130.

In operation 315, the computer system 100 may generate the first inference result for the first input using the VLM 50. For example, the first inference result may be at least a portion of the inference result for the first input 11 (or first frame).

In operation 320, the computer system 100 may maintain the cached information even after the first inference result for the first input is generated. That is, the cached information may be stored without being deleted (or flushed) even after the first inference result is generated, and may be maintained until generation of the second inference result for the remaining second input(s) following the first input is completed. That is, information associated with the input prompt 20 may be maintained in the memory 130 independently of inference operation for the inputs 10 using the VLM 50.

Meanwhile, the information associated with the input prompt 20 that is cached and maintained may include a text token constituting the input prompt and attention information acquired during an operation for generating the first inference result.

In operation 330, the computer system 100 may generate the second inference result for the second input following the first input among the consecutive inputs 10 to the VLM 50, based on information associated with the input prompt 20, that is, cached information that is cached and maintained in operations 310 and 320. That is, the computer system 100 may quickly generate the second inference result without a need to perform a redundant operation by using the information cached when generating the first inference result to generate the second inference result for the second input following the first input. As such, in an example embodiment, when performing the operation for generating the second inference result for the second input, the cached information may be stored in a form acquirable by the VLM 50, and this cached information may be maintained without being removed until the inference results for all the consecutive inputs 10 are generated.

Meanwhile, for example, when the first input is the first frame 11 of the video stream, the second input may be subsequent frame(s) following the first frame 11 among the frames of the video stream. In this example, the input prompt 20 may be a text prompt applied to analyze or explain each of the frames of the video stream using the VLM 50. The first inference result generated using the VLM 50 may be configured to include text that analyzes or explains the first frame 11, and the second inference result may be configured to include text that analyzes or explains the subsequent frame. As such, the VLM 50 may be configured to perform inference of detecting a specific event (e.g., vehicle accident and fire) from visual information included in the input video stream.

Meanwhile, in operation 315 described above, the first inference result for the first input may be generated by performing operations 316 and 318.

In operation 316, the computer system 100 may generate text tokens constituting the input prompt 20, from the input prompt 20, and may generate first visual token(s) from an image or a frame included in the first input.

In operation 318, the computer system 100 may generate a first output token using the VLM 50 based on the text tokens and the first visual token(s). The first output token may be at least a portion of the first inference result. The computer system 100 may complete generation of the first inference result by sequentially generating the first output tokens. In an example embodiment, attention information acquired during an operation in the process of generating an initial first output token (e.g., during a prefill stage in a inference result generation process) or during an operation in the process of generating each first output token may be cached.

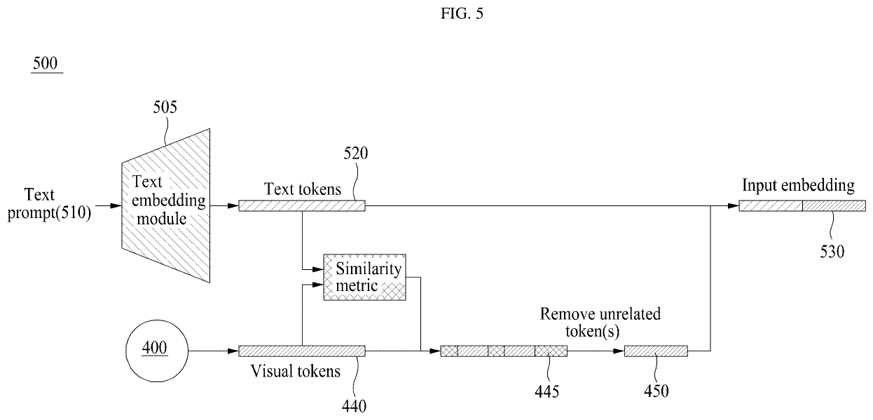

The VLM 50 may include a plurality of transformers. Each transformer may include an attention mechanism (e.g., self-attention mechanism). In an example embodiment, as a first input embedding (e.g., input embedding 530 of FIG. 5 described below) generated based on the input prompt 20 and the first is input to at least one transformer (i.e., transformer block) that includes the attention mechanism constituting the VLM 50, the first output token constituting the first inference result may be generated. This first output token may be a text token.

Meanwhile, the attention information cached during the operation of generating the first output token may include at least one of a key, a value, and an attention output of the attention mechanism of the transformer.

Since the VLM 50 may include the plurality of transformers, the computer system 100 may cache the text token constituting the input prompt 20 and at least one of a key, a value, and an attention output of the attention mechanism of each of the plurality of transformers constituting the VLM50 as the attention information. For example, the computer system 100 may cache the key and the value as the attention information.

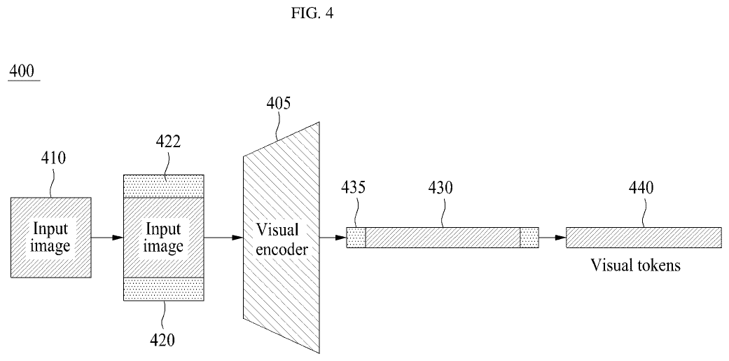

More details of a method of generating text tokens and first visual tokens, and cached attention information are further described with reference to FIGS. 4 to 9 below.

Also, the second inference result for the second input as in operation 330 described above may be generated by performing operations 332 and 334.

In operation 332, the computer system 100 may generate second visual token(s) from an image or a frame included in the second input.

In operation 334, the computer system 100 may generate a second output token using the VLM 50 based on the second visual token(s) and the cached information that is cached and maintained in operations 310 and 320. The second output token may be at least a portion of the second inference result. The computer system 100 may complete generation of the second inference result by sequentially generating the second output tokens. In an example embodiment, the cached information may be used during the operation in the process of generating each second output token.

More details of a method of generating second visual tokens and a method of generating the second output token (second inference result) using cached information (attention information) are further described with reference to FIGS. 4 to 9 below.

Description related to technical features made above with reference to FIGS. 1 and 2 may be applied to FIG. 3 as is and thus, repeated description is omitted.

In the following, a method of generating visual tokens used for inference using the VLM 50 from each of the consecutive inputs 10 is further described with reference to FIGS. 4 and 5.

FIG. 4 illustrates a method of generating a significant visual token by performing padding processing on an input image and then removing a visual token corresponding to a padded area according to an example.

FIG. 4 illustrates a method of generating visual tokens 440 used for inference using the VLM 50 from an input image 410 that is one input among the consecutive inputs 10 described above (400).

The input image 410 may be, for example, the aforementioned first input or second input. The input image 410 may include an image or a frame. In the following, an example embodiment is described by assuming the input image 410 as the first input 410 for clarity of description.

To generate the first visual tokens 440 from the first input 410, the computer system 100 may pad at least one pixel outside the image or the frame included in the first input 410. Accordingly, as illustrated, the first input 410 may be reconstructed as a padded image 420 that includes padded area(s) 422. As illustrated, the padded area(s) 422 may be formed at the upper end and/or lower end of the first input 410, or may be formed at the left end and/or right end of the first input 410. The computer system 100 may generate visual tokens 430 from the padded image 420 using a visual encoder 405. That is, the visual encoder 405 may be configured to receive the image and to output the visual tokens. For example, an image encoder of CLIP (Contrastive Language-Image Pre-training) may be used as the visual encoder 405. The visual encoder 405 may include a vision transformer. The computer system 100 may remove at least one unrelated visual token 435 among the generated visual tokens 430. The first visual token 440 may be acquired by removing the unrelated visual token 435. The unrelated visual token 435 may be a visual token corresponding to a location of a padded pixel of the padded image 420. The computer system 100 may use a known location of the padded pixel to identify the visual token corresponding to the location of the padded pixel among the visual tokens 430 and may remove the identified visual token as the unrelated visual token 435. As a result, the first visual tokens 440 may be acquired. That is, the visual tokens 435+430 may be generated using the visual encoder 405 and the first visual tokens 440 may be acquired by extracting the remainder excluding the unrelated visual tokens from among the generated visual tokens 435+430.

A method of removing the unrelated visual token 435 described with reference to FIG. 4 may effectively remove a visual token (i.e., visual token that does not contain significant visual information) resulting from unnecessary pixels added to width and/or height of the image to convert the image to a predetermined resolution in a processing process.

FIG. 5 illustrates a method of removing an additional unrelated visual token that may be additionally/or selectively used in the method of removing the unrelated visual token 435 of FIG. 5.

FIG. 5 illustrates a method of removing unrelated token(s) based on similarity to text tokens and generating a visual token (i.e., selecting or extracting a significant visual token) according to an example.

FIG. 5 illustrates a method of additionally identifying and removing unrelated visual token(s) 445 with respect to the first visual tokens 440 described above with reference to FIG. 4 (500). However, depending on example embodiments, the method of identifying and removing the unrelated visual token(s) 445 may also be applied to the visual tokens 430.

A text prompt 510 may be the input prompt 20 described above with reference to FIGS. 1 to 4. The computer system 100 may generate text tokens 520 from the text prompt 510 using a text embedding module 505. That is, the text embedding module 505 may be configured to receive the text prompt and to output the text tokens.

Considering similarity relationship between the visual tokens 440 or 430 acquired through the process shown in FIG. 4 and the above text tokens, the unrelated visual token 445 may be identified among the visual tokens 440 or 430. The computer system 100 may generate final first visual tokens 450 by removing the identified unrelated visual token 445. For example, the computer system 100 may identify and remove a visual token of which similarity to the text tokens 520 is less than or equal to a predetermined value among the visual tokens 430 or 440 as the unrelated visual token 445. Cosine similarity may be used as a similarity index (similarity metric) to compare the similarity between the visual tokens 430 or 440 and the text tokens 520.

The method of removing the unrelated visual token 445 described with reference to FIG. 5 may distinguish tokens that need to be focused and tokens that do not need to be focused among visual tokens through comparison with the text prompt 510 and may select only tokens that need to be focused, thereby contributing to improving the inference speed by reducing a size of input to a language model while minimizing degradation in the performance of the VLM 50.

By processing the first input 410 in a manner described in FIG. 4 and/or FIG. 5, the first visual tokens 450 used for inference using the VLM 50 may be generated from the first input 410.

Meanwhile, the text tokens 520 constituting the text prompt 510 may be cached and then used for processing of a second input.

The computer system 100 may generate a first input embedding 530 based on the first visual token(s) 450 constituting the first input 410 (i.e., constituting visual information of the first input 410) and the text token(s) 520 constituting the input prompt 20 (text prompt 510). The first input embedding 530 may be input to at least one transformer (i.e., transformer block) that includes an attention mechanism constituting the VLM 50 and accordingly, the VLM 50 may output a first output token constituting a first inference result. That is, as the first input embedding 530 is input to the transformer of the VLM 50, the computer system 100 may perform an operation for generating the first output token.

Here, the computer system 100 may cache attention information acquired during the operation for generating the first output token and may use the cached attention information when generating a second output token constituting a second inference result for the second input.

In the following, a method of generating second visual tokens used for inference using the VLM 50 from the second input is further described.

The second input may be processed in a similar manner as processing the first input described with reference to FIG. 4 and accordingly, (second) visual tokens used to generate the second inference result may be acquired from the second input and thus, repeated description related to is omitted. That is, the computer system 100 may pad at least one pixel outside the image or the frame that is the second input and may generate visual tokens from the padded image or frame using the visual encoder 405. The computer system 100 may remove at least one unrelated visual token among the visual tokens from this padded image or frame. Here, the computer system 100 may identify and remove a visual token corresponding to a location of the padded pixel among the visual tokens from the padded image or frame as the unrelated visual token. As this unrelated visual token is removed, the second visual tokens may be acquired from the second input.

Also, the method of removing the additional unrelated visual token described above with reference to FIG. 5 may be similarly applied to generating the second visual token. However, unlike in processing the first input, in processing the second input, generation of text tokens by a text embedding module may not be performed and cached text tokens may be used to determine similarity between tokens.

For example, the computer system 100 may remove, as an additional unrelated visual token, a visual token of which similarity to a text token cached when processing the first input for generating first visual tokens is less than or equal to a predetermined value among visual tokens generated from the second input (i.e., the aforementioned visual tokens among which the visual token corresponding to the location of the padded pixel is removed or not removed). Accordingly, the computer system 100 may generate second visual token(s) constituting the second input (i.e., constituting visual information of the second input) by processing the second input.

The second visual token(s) may be input to at least one transformer (i.e., transformer block) that includes the attention mechanism constituting the VLM 50 and accordingly, the VLM 50 may output the second output token constituting the second inference result according to operation using the cached attention information. That is, the computer system 100 may generate the second output token constituting the second inference result based on the attention information that is acquired and cached during the operation for generating the first output token as the second visual token is input to the transformer of the VLM 50.

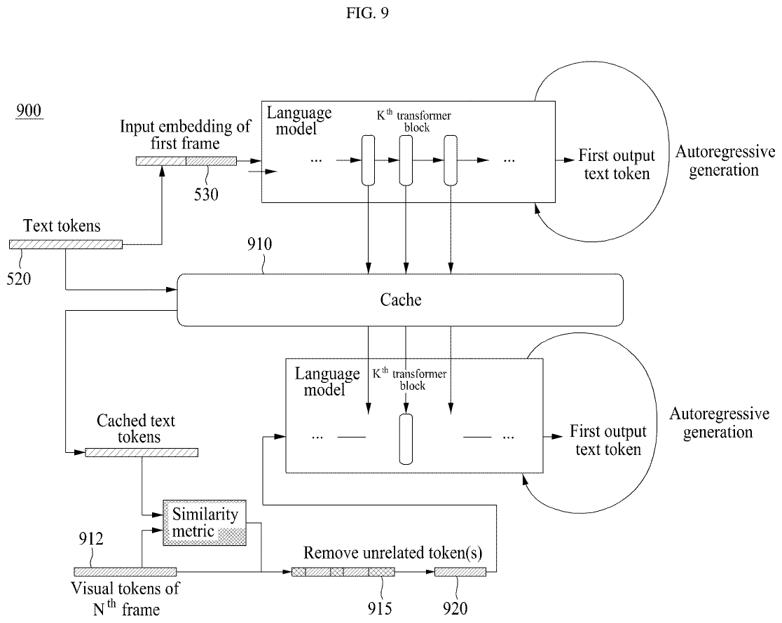

In this regard, FIG. 9 illustrates a method of performing, by a VLM, inference using cached information associated with an input prompt when processing visual tokens of consecutive inputs generated by the methods described with reference to FIGS. 4 and 5, according to an example.

FIG. 9 illustrates a method of generating the first output token (text token) as the first input embedding 530 (i.e., input embedding of the first frame) acquired based on the first input processing method described above with reference to FIGS. 4 and 5 is input to the language model of the VLM 50 (i.e., transformers of the VLM 50); and generating the second output token (text token) as visual tokens 912 (i.e., visual tokens of N^{th} frame) acquired from the second input are processed and then input to the transformers of the VLM 50 according to the method described above with reference to FIG. 4 (900).

As described above, unrelated visual tokens 915 may be additionally removed from the visual tokens 912 acquired from the second input through similarity comparison with cached text tokens and accordingly, final second visual tokens 920 may be acquired. The cached text tokens may be the text tokens 520 that are generated in the process of generating the first input embedding 530 from the first input in a cache 910. The cache 910 may represent one area on the memory 130.

The method of caching attention information and generating the first output token by inputting, to the VLM 50, the first input embedding 530 corresponding to the input embedding of the first frame is further described.

As illustrated, the first input embedding 530 may be configured such that the text token constituting the input prompt 20, 510 is arranged before the first visual token constituting the first input (i.e., including visual information of the first input).

When the first input embedding 530 is input to the language model of the VLM 50, an attention operation may be performed while the first input embedding 530 passes through each of the plurality of transformers constituting the language model and, as a result thereof, the first output token that is the text token may be output from the language model. After the first output token corresponding to a first text token is output, subsequent first output tokens may be generated through autoregressive generation and accordingly, the first inference result may be generated. In the process of generating initial or each first output token, at least one (or all) of a key, a value, and an attention output of the attention mechanism acquired according to the attention operation of each transformer may be stored in the cache 910 as the aforementioned attention information.

Hereinafter, the method of generating the second output token by inputting, to the VLM 50, the second visual tokens 920 that include visual information of the second input, that is, the N^{th} frame is further described.

Here, although the second visual tokens 920 are input to the language model, the text embedding including information of the input prompt 20, 510 may not be input to the language model and information stored in the cache 910 may be used to generate the second output token as information associated with the input prompt 20, 510. That is, the cached attention information may be used for the attention operation performed while the second visual tokens 920 pass through each of the plurality of transformers constituting the language model. Here, attention information acquired and cached from a Kth (K is integer of 1 or more) transformer block during the operation of generating the first output token may be used for the operation of the Kth transformer block for generating the second output token. For example, the computer system 100 may generate an operation result of a subsequent transformer using a cached key, a cached value, and operation result of a previous transformer. As a result of inference, the language model may output the second output token that is the text token. After the second output token corresponding to the first (i.e., initial) text token is output, subsequent second output tokens may be generated through autoregressive generation and accordingly, second inference results may be generated.

Accordingly, when generating the second inference result, operations using overlapping information associated with the input prompt 20, 510 may not be performed, thereby resolving the bottleneck in the language model and accordingly, the inference speed may be improved.

Description related to technical features made above with reference to FIGS. 1 to 3 may be applied to FIGS. 4, 5, and 9 as is and thus, repeated description is omitted.

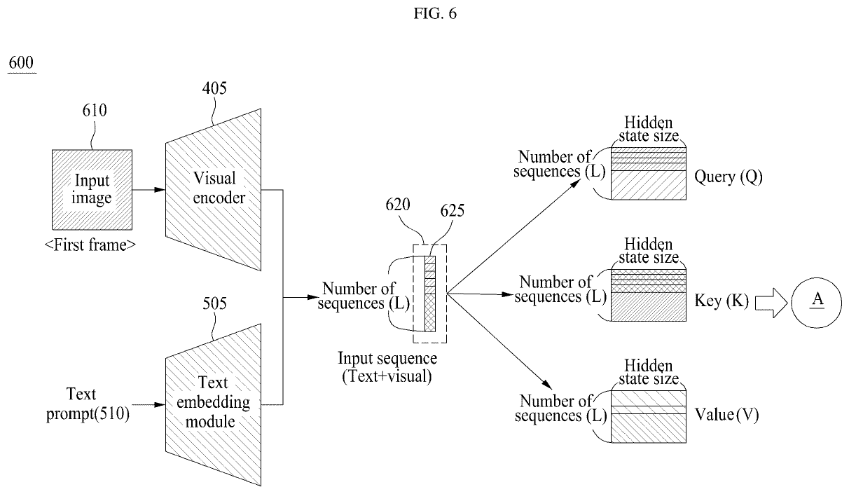

A method of caching attention information in the process of generating the first inference result and generating the second inference result using the cached attention information is further described with reference to FIGS. 6 to 8.

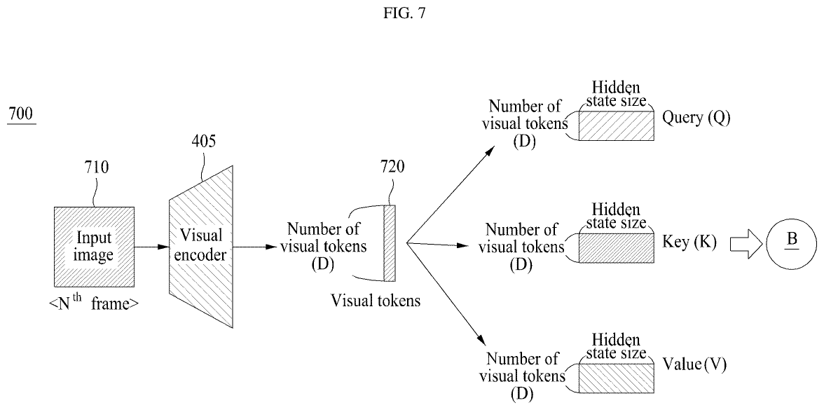

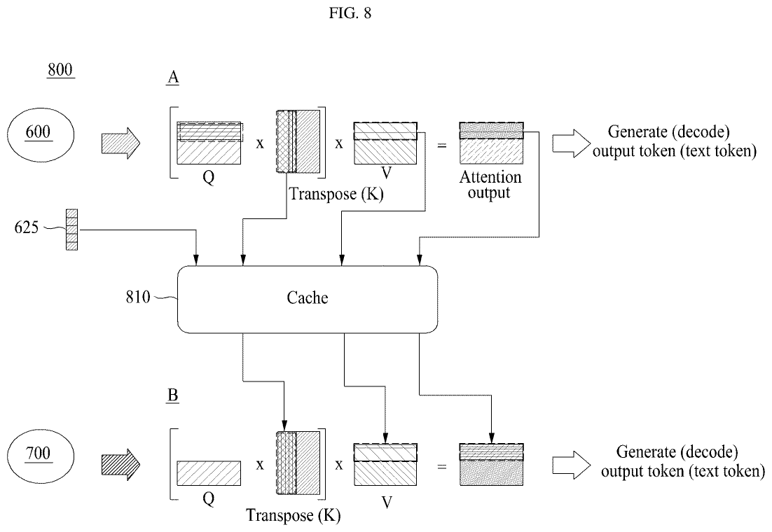

FIG. 6 illustrates a method of processing a first input among consecutive inputs to perform inference by a VLM according to an example. FIG. 7 illustrates a method of processing an N^{th} input among consecutive inputs to perform inference by a VLM according to an example. FIG. 8 illustrates a method of caching information associated with an input prompt while a VLM performs inference on a first input and performing inference on an N^{th} input using the cached information according to an example.

FIGS. 6 to 8 schematically represent a method in which the computer system 100 generates a first input embedding 620 by processing a first frame of a video stream as a first input 610 (600): generates second visual tokens 720 by processing an N^{th} frame of the video stream as a second input 710 (700): generates a first output token as a text token by performing an attention operation on the first input embedding 620, and, here, caches text tokens 625 and also caches attention information representing a portion 625 associated with the text prompt 510 in the attention information acquired in the process of generating the first output token (A of 800); and uses the cached attention information when generating a second output token by performing the attention operation on the second visual token 720 (B of 800). The first input embedding 620 may correspond to the aforementioned first input embedding 530. In FIGS. 6 to 8, an operation in a prefill stage in an inference result generation process by the VLM 50 is illustrated and a portion corresponding to a decoding stage is omitted.

As illustrated, information associated with the text prompt 510 stored in a cache 810 may be the text tokens 625 and a key, a value, and an attention output acquired during the attention operation for the first input embedding 620 as the attention information. Only a portion related to the text prompt 510 may be identified among the key, the value, and the attention output and then stored in the cache 810 as the attention information. Meanwhile, the cache 810 may correspond to the cache 910 described above with reference to FIG. 9.

As described above, an example embodiment may reduce redundancy in the attention operation by using the cached text tokens 625 and the cached attention information to generate the second inference result and accordingly, may increase the inference speed while reducing the overall size of the VLM 50.

Description related to technical features made above with reference to FIGS. 1 to 5 and FIG. 9 may be applied to FIGS. 6 to 8 and thus, repeated description is omitted.

Caching of information associated with the input prompt 20 in the example embodiment may also be referred to as prompt caching. Prompt caching of the example embodiment may significantly reduce the bottleneck in the language model corresponding to the bottleneck in the largest operation in inference using the VLM 50. The language model repeats a task of generating a text token from an input text token (e.g., the aforementioned input embedding 530) (Causal Generation), which is very disadvantages in terms of the inference speed and memory use. That is, since the attention operation of the transformer included in the language model is greatly affected by the length of processing input, repeated operations are very disadvantages in terms of the inference speed.

To solve such problems in processing inference on the consecutive inputs 10, such as a video stream, using the VLM 50, an example embodiment may cache text tokens constituting the input prompt 20, information associated with the input prompt 20 repeated for all the inputs 10, and attention information acquired when performing inference on the first input, and may use the same when performing inference on subsequent inputs.

In an inference result generation process of a general language model (e.g., large language model (LLM)), a method of storing a key and a value corresponding to attention information in a prefill stage that is a stage of initially processing an input sequence, and using the same in a subsequent decoding state may have difficulty in being applied to the VLM 50 of the example embodiment that needs to perform inference on the consecutive inputs 10. That is, the above method applicable only when generating an output token corresponding to the decoding stage may not be applied as is to the VLM 50 of the example embodiment of repeatedly applying information of the input prompt 20.

For example, in the case of detecting an event by analyzing the video stream, the consecutive inputs 10, using the VLM 50 of the example embodiment, the same input prompt 20 may be input to each frame of the video stream. As such, the method of applying cached information (the aforementioned key and value) only in the stage (i.e., decoding stage) of generating the output token may not be applied to the VLM 50 in which information is repeated at an input token end.

An example embodiment may construct an input embedding such that a text token constituting the input prompt 20 is arranged before a first visual token constituting a first input, as shown in FIG. 9, without constructing the input embedding such that an image token is located ahead of a text token.

Therefore, the VLM 50 of the example embodiment may be pretrained to perform inference on this input embedding. That is, the VLM 50 may be pretrained using a training input embedding that includes a training visual token (visual token of training image) and a training text token (text token of input prompt), and the training input embedding may also be configured such that the training text token is arranged before the training visual token. As such, the VLM 50 of the example embodiment may be trained by modifying data such that the image token is located at the end of an input token list.

As described above with reference to FIGS. 6 to 8, in the example embodiment, in the process of generating the inference result for the first frame (A of 800), the text token of the text prompt 510, the key corresponding to the text portion 625, the value corresponding to the text portion 625, and the attention output value corresponding to the text portion 625 during the operation in the prefill stage may be stored in the cache 810 for each transformer block. After the prefill stage for the first frame is completed, information stored in the cache 810 may be used for an operation for inference in an operation in a prefill stage of a subsequent frame. Prompt caching of the example embodiment may cache and maintain values acquired in the operation in the prefill stage for the first frame and may use the cached values for operations in prefill stages of all the subsequent frames.

Meanwhile, as described above with reference to FIGS. 4, 5, and 9, the computer system 100 may generate sequential inference results from the consecutive inputs 10 by removing a visual token corresponding to a padded pixel to select a significant visual token from an input (FIG. 4), removing a visual token with low similarity in consideration with correlation to the input prompt 20 (FIG. 5), and then applying prompt caching of the example embodiment. As illustrated in FIG. 9, in the process of performing inference on the first frame, the text tokens 520 are stored in the cache 910. Therefore, when performing inference on subsequent frames, only encoding on the frame (i.e., image) needs to be performed and accordingly, an amount of time used for inference on the entire inputs may be significantly reduced.

As described above, the VLM 50 of the example embodiment may reduce redundancy of operations when performing inference on the continuous inputs 10 and may be implemented with the high inference speed while being small in size.

The apparatuses described herein may be implemented using hardware components, software components, and/or combination of the hardware components and the software components. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, virtual equipment, or computer storage medium or device, to provide instructions or data to or to be interpreted by the processing device. The software also may be distributed over network coupled computer systems so that the software is stored and executed in a distributed fashion. The software and data may be stored by one or more computer readable storage mediums.

The methods according to the example embodiments may be implemented in the form of program instructions executable through various computer methods and recorded in computer-readable media. Here, the media may continuously store computer-executable programs or may temporarily store the same for execution or download. Also, the media may be various types of recording devices or storage devices in the form in which one or a plurality of hardware components are combined. Without being limited to media directly connected to a computer system, the media may be distributed over the network. Examples of the media include magnetic media such as hard disks, floppy disks, and magnetic tapes: optical media such as CD ROM and DVD: magneto-optical media such as floptical disks; and hardware devices that are specially to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software.

Although the example embodiments are described with reference to some specific example embodiments and accompanying drawings, it will be apparent to one of ordinary skill in the art that various alterations and modifications in form and details may be made in these example embodiments. For example, suitable results may be achieved if the described techniques are performed in different order, and/or if components in a described system, architecture, device, or circuit are combined in a different manner, or replaced or supplemented by other components or their equivalents.

Therefore, other implementations, other example embodiments, and equivalents of the claims are to be construed as being included in the claims.

What is claimed is:

1. An inference method using a vision-language model (VLM), performed by a computer system, the VLM being pretrained to sequentially generate inference results for consecutive inputs according to an input prompt, the inference method comprising:
caching information associated with the input prompt acquired during an operation for generating a first inference result for a first input among the consecutive inputs to the VLM:
maintaining the cached information after the first inference result is generated; and
generating a second inference result for a second input following the first input among the consecutive inputs to the VLM, based on the cached information.

2. The inference method of claim 1, wherein the consecutive inputs correspond to a video stream including a plurality of frames,
the first input is a first frame being an initial frame among the frames, and the second input is a subsequent frame following the first frame among the frames,
the input prompt is a text prompt applied to analyze or explain each frame of the frames using the VLM, and
the first inference result includes text that analyzes or explains the first frame, and the second inference result includes text that analyzes or explains the subsequent frame.

3. The inference method of claim 1, wherein the cached information associated with the input prompt includes a text token constituting the input prompt and attention information acquired during an operation for generating the first inference result.

4. The inference method of claim 3, wherein, as a first input embedding generated based on the input prompt and the first input is input to at least one transformer including an attention mechanism constituting the VLM, a first output token constituting the first inference result is generated, and
at least one of a key, a value, and an attention output of the attention mechanism is cached as the attention information.

5. The inference method of claim 4, wherein the VLM includes a plurality of transformers, and
the caching comprises caching the text token constituting the input prompt and at least one of the key, the value, and the attention output of the attention mechanism of each of the plurality of transformers constituting the VLM as the attention information.

6. The inference method of claim 4, wherein the first input includes an image or a frame, and
the first input embedding is generated based on the text token constituting the input prompt and a first visual token constituting the first input, and
the first visual token is generated by performing:
padding at least one pixel outside the image or the frame;
generating visual tokens from the padded image or frame using a visual encoder; and
removing at least one unrelated visual token among the visual tokens.

7. The inference method of claim 6, wherein the removing comprises removing a visual token corresponding to a location of the padded pixel among the visual tokens as the unrelated visual token.

8. The inference method of claim 6, wherein the removing comprises removing a visual token of which similarity to the text token is less than or equal to a predetermined value among the visual tokens as the unrelated visual token.

9. The inference method of claim 4, wherein the second input includes an image or a frame, and
the generating of the second inference result comprises:
generating a second visual token constituting the second input; and
generating a second output token constituting the second inference result based on the cached attention information as the second visual token is input to the transformer.

10. The inference method of claim 9, wherein the generating of the second visual token comprises:
padding at least one pixel outside the image or the frame that is the second input;
generating visual tokens from the padded image or frame using a visual encoder; and
removing at least one unrelated visual token among the visual tokens.

11. The inference method of claim 10, wherein the removing comprises removing a visual token corresponding to a location of the padded pixel among the visual tokens as the unrelated visual token.

12. The inference method of claim 10, wherein the removing comprises removing a visual token of which similarity to the cached text token is less than or equal to a predetermined value among the visual tokens as the unrelated visual token.

13. The inference method of claim 1, wherein the VLM is pretrained using a training input embedding that includes a training visual token and a training text token, and
the training input embedding is configured such that the training text token is arranged before the training visual token.

14. The inference method of claim 4, wherein the first input embedding is configured such that the text token constituting the input prompt is arranged before a first visual token constituting the first input.

15. The inference method of claim 4, wherein the cached information is stored in a form acquirable by the VLM when performing an operation for generating the second inference result for the second input, and is maintained without being removed until the inference results are generated for all of the consecutive inputs.

16. A non-transitory computer-readable recording medium to execute the method of claim 1 on the computer system.

17. A computer system to perform inference using a vision-language model (VLM), the VLM being pretrained to sequentially generate inference results for consecutive inputs according to an input prompt, the computer system comprising:
at least one processor configured to execute computer-readable instructions on the computer system,
wherein the at least one processor is configured to cache information associated with the input prompt acquired during an operation for generating a first inference result for a first input among the consecutive inputs to the VLM, to maintain the cached information after the first inference result is generated, and to generate a second inference result for a second input following the first input among the consecutive inputs to the VLM, based on the cached information.
